(19) United States
(12) Patent Application Publication
(10) Pub. No.: US 2009/0102545 A1
(43) Pub. Date: Apr. 23, 2009

(54) SIGNAL PROCESSING METHOD AND SIGNAL PROCESSING APPARATUS

(76) Inventors: Shigetaka Takagi, Tokyo (JP); Nobuo Fujii, Tokyo (JP); Takahide Sato, Tokyo (JP); Kazuyuki Wada, Aichi (JP)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/917,692

(22) PCT Filed: Apr. 25, 2006
(86) PCT No.: PCT/JP2006/309123

§ 371 Date: Dec. 14, 2007

(30) Foreign Application Priority Data
Jun. 15, 2005 (JP) 2005-175052

(51) Int. Cl. H04B 1/10

(52) U.S. Cl. 327/551

(57) ABSTRACT

An input signal (Vin) is divided into n (≧3) number of divided signals which are weighted by first weights (ki). The weighted divided signals are processed by n number of signal processing means 1 to n performing the same signal processing. The processed divided signals are weighted by second weights (li) and added to obtain an output signal (Vout). By selecting the first weights (ki) and the second weights (li), it is possible to eliminate noise or eliminate distortion.

### TECHNICAL FIELD

The present invention relates to a signal processing method and signal processing apparatus able to reduce noise.

### BACKGROUND OF THE INVENTION

In the field of signal processing, reduction of noise has always been desired. In recent years, however, due in part to the lower power voltages used, even greater noise resistant circuits have been demanded. As noise resistant circuits, “balanced configuration” or “differential configuration” circuits are known. For example, in mixed analog/digital integrated circuits, the noise from the digital circuits often enters the analog circuits as in-phase components, so the practice has been to use a balanced configuration circuit to reduce the noise. A balanced circuit is shown in FIG. 18. The input Vin passes through the first signal processing circuit 51 which then outputs H(s)Vin. On the other hand, the input Vin is multiplied with −1 to obtain −Vin. This −Vin is passed through a second signal processing circuit 52 performing the same signal processing as the first signal processing circuit 51. After this, it is further multiplied with −1 to output H(s)Vin. If these are added by the adder 53, the result becomes 2H(s)Vin, whereby a signal comprised of the input signal Vin processed by H(s) is obtained. To make the output H(s)Vin, it is sufficient to set the input voltages to ½ respectively. On the other hand, regarding the noise N applied to the signal processing circuits 51, 52, the output of the first signal processing circuit 51 becomes N and the output of the second signal processing circuit 52 becomes −N. These cancel each other out by addition by the adder 53 (for example, see M. Banu and Y. Tsividis, “Fully Integrated Active RC Filters in MOS Technology”, IEEE Journal of Solid-State Circuits, Vol. SC-18, No. 6, December. 1983).

In this way, with a balanced configuration, the noise components can be eliminated by processing a signal divided into two, but only the in-phase components can be eliminated. Due to this limitation, there was the problem that even with the balanced configuration, the noise reduction effect was low. Further, there was the problem that even order distortion could be eliminated, but odd order distortion such as third order distortion becoming a problem in communication systems could not be eliminated.

### DISCLOSURE OF THE INVENTION

The present invention considers the above problem and has as its object the provision of a signal processing method and signal processing apparatus with a high noise reduction effect and a high distortion eliminating effect.

To achieve the above object, the signal processing method of the present invention has a step of weighting a signal by first weights to obtain three or more divided signals, a step of processing said divided signals by the same signal processing, a step of weighting said processed divided signals by second weights, and a step of adding the divided signals weighted by said second weights.

Further, the signal processing apparatus of the present invention is provided with a first weighting means for weighting a signal by first weights to obtain three or more divided signals, a signal processing means for processing said divided signals by the same signal processing, a second weighting means for weighting said processed divided signals by second weights, and an adding means for adding the divided signals weighted by said second weights.

When said signal is a complex signal, said second weights can be made complex conjugate with the corresponding first weights, and said first weights can be selected from 1, −1, j, −j.

Further, when said signal is a real signal, said second weights can be made the same as the corresponding first weights, and said first weights can be selected from 1 and −1.

Further, the first weights may be a combination selected to maximize the noise reduction effect.

When said signal is a real signal, said second weights are given as functions of said first weights. Further, said second weights may be given as solutions of simultaneous equations having said second weights as unknowns and having values calculated from said first weights as coefficients. In this case, said second weights can also be calculated from the first weights so as to decrease the distortion components.

The present invention selects the weighting for the input signal and divides the signal into three or more divided signals for processing, so can increase the noise reduction effect and can increase the distortion elimination effect.

### BRIEF DESCRIPTION OF THE DRAWINGS

FIG. 1 is a view showing the concept of a signal processing apparatus of the present invention.

FIG. 2 is a view showing a resistance model of an integrated circuit board used for simulation of the first embodiment.

FIG. 3 is a view showing an Al interconnect model on an integrated circuit board used for simulation of the first embodiment.

FIG. 4 is a view showing a side view of an Al interconnect model on an integrated circuit board.

FIG. 5 is a view showing the magnitude of noise of an Al interconnect model.

FIG. 6 is a view showing a signal processing apparatus for reducing noise of a complex signal (first embodiment).

FIG. 7 is a view specifically showing a signal processing apparatus for a complex signal.

FIG. 8 is a view for explaining a signal processing apparatus for a complex signal.

FIGS. 9(a) and (b) are views showing a balanced circuit configuration of a comparative example balanced circuit.

FIG. 10 is a view showing the results of simulation of output noise.

FIG. 11 is a view of a signal processing apparatus for reducing signal distortion of a real signal (second embodiment).

FIG. 12 is a view showing a table of correspondence between weighting and the noise level of the second embodiment (division into four).

FIG. 13 is a view showing a table of correspondence between weighting and the noise level of a modification of the second embodiment (division into 16).

FIG. 14 is a view showing a specific example of the circuit of the second embodiment (division into four) shown in FIG. 11.

FIG. 15 is a view of a first modification of the signal processing circuit of FIG. 14.

FIG. 16 is a view of a second modification of the signal processing circuit of FIG. 14.

FIG. 17 is a view of a signal processing apparatus for reducing signal distortion of a real signal (third embodiment).

FIG. 18 is a view of a signal processing apparatus of a conventional balanced configuration.

### DESCRIPTION OF NOTATIONS

10 signal processing apparatus
1 to n signal processing circuits
kₙ input weights
lₙ output weights
20 integrated circuit board
30 interconnects

### BEST MODE FOR CARRYING OUT THE INVENTION

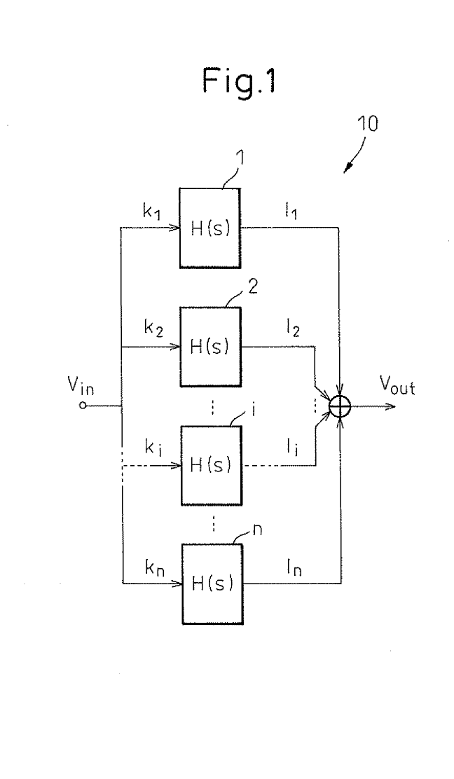

Before explaining the embodiments of the invention, the basic configuration of the present invention will be explained with reference to FIG. 1. FIG. 1 shows a signal processing apparatus 10 according to the present invention. The signal processing apparatus 10 is provided with n (n≧3) number of a first signal processing circuit 1 to n-th signal processing circuit n which perform the same signal processing H(s). A signal Vin input to the signal processing apparatus 10 is multiplied with weighting coefficients k1 to kn to divide it into n parts which are then input to the first to n-th signal processing circuits 1 to n. The outputs of the first to n-th signal processing circuits 1 to n are multiplied with weighting coefficients l1 to ln and then output. These n number of outputs are added to obtain the output Vout of the signal processing apparatus according to the present invention.

The present invention, as will be explained in detail below, can configure a circuit to reduce noise or a circuit to reduce signal distortion by selecting n (n≧3) number of weighting coefficients in accordance with the objective.

The principle of elimination of noise of one aspect of the present invention is to expand the principle of elimination of noise of the conventional balanced configuration to the greater dimensions of three dimensions or more. The conventional balanced configuration can be considered to process noise by breaking it down into vectors perpendicularly intersecting in two dimensions. On the other hand, the present invention uses the n number of signal processing circuits shown in FIG. 1 and uses the weighting coefficients k1 to kn and l1 to ln. Therefore, the present invention can be said to process noise by breaking it down into three dimensional or greater n-dimensional vectors. In the present invention, in general, the output side vectors l are complex conjugates with the components of the input side vectors k. That is, the weighting coefficients l1 to l2 are complex conjugates of the input side weighting coefficients k1 to kn. In the case of an input signal of only a real number of course, the output side vectors l should be set equal to the vectors k.

The operation of a conventional balanced circuit is expressed by the following formula where the input is expressed as Vin and the signal processing of the balanced circuit is expressed as H(s):

$$[ 1 - 1 ] H ( s ) ( \begin{matrix}1 \\ - 1\end{matrix} ) {V}_{in} = 2 H ( s ) {V}_{in} \qquad ( 1 )$$

That is, in a balanced circuit, the input signal Vin is multiplied with the vector [1 −1]^{T} to divide it into two signals which are then processed, then multiplied with the vector [1 −1] and added to obtain the output signal 2H(s)Vin. However, for example, in the case of noise Vnoise from the digital circuit considered to be in-phase components in a mixed analog/digital circuit, the Vnoise is multiplied with the vector [1 1]^{T},

$$[ 1 - 1 ] H ( s ) ( \begin{matrix}1 \\ 1\end{matrix} ) {V}_{noise} = 0 \qquad ( 2 )$$

and removed. What the two equations mean is that the fact that the two dimensional vector [1 −1]^{T} and two dimensional vector [1 1]^{T} are perpendicular is utilized, only the components parallel to the vector [1 −1]^{T} are output, and the components parallel to the perpendicular vector [1 −1]^{T} are removed.

In this way, the conventional balanced configuration divides the signal into two and considers two-dimensional vectors, while the present invention divides it into n (≧3) and considers the n-(≧3) dimensional vectors. According to the noise elimination configuration of the present invention, only the components parallel to the n-dimensional vectors are output. The components perpendicular to this are eliminated, so if selecting suitable n-(≧3) dimensional vectors, the eliminated perpendicular components increase and therefore the noise reduction effect becomes greater.

Below, a first embodiment of the present invention will be explained with reference to the drawings. Further, the differences in actions and effects with the conventional art will be explained. That is, the effect of reduction of noise riding on the interconnects of the integrated circuit will be explained by a comparison of a signal processing circuit of the first embodiment of the present invention and a conventional balanced circuit.

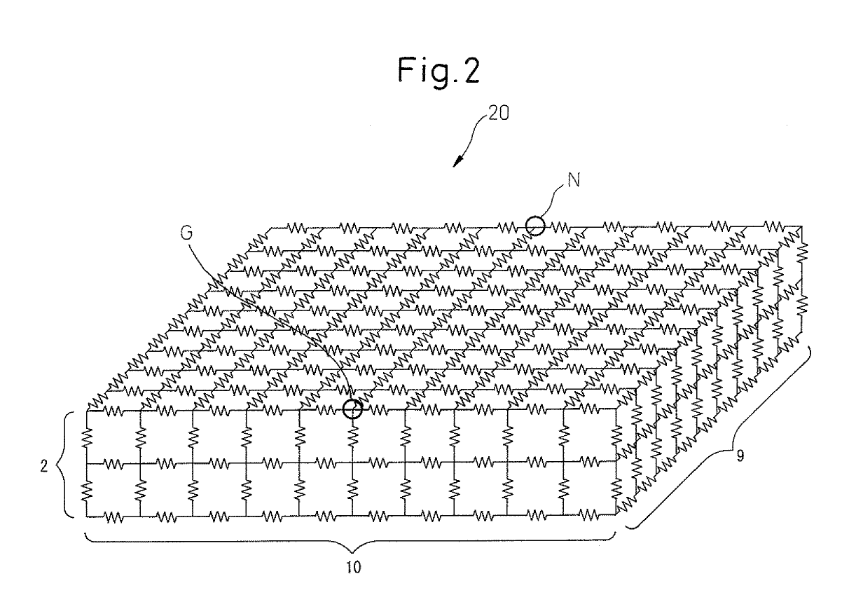

FIG. 2 expresses an integrated circuit board 20 by a resistance network. A model of the circuit board 20 is created by 10 resistances laterally, nine longitudinally, and two in height. It is assumed that there is a noise source at the point N in the figure, that is, power is connected at the point N as a noise source and grounded at the point G.

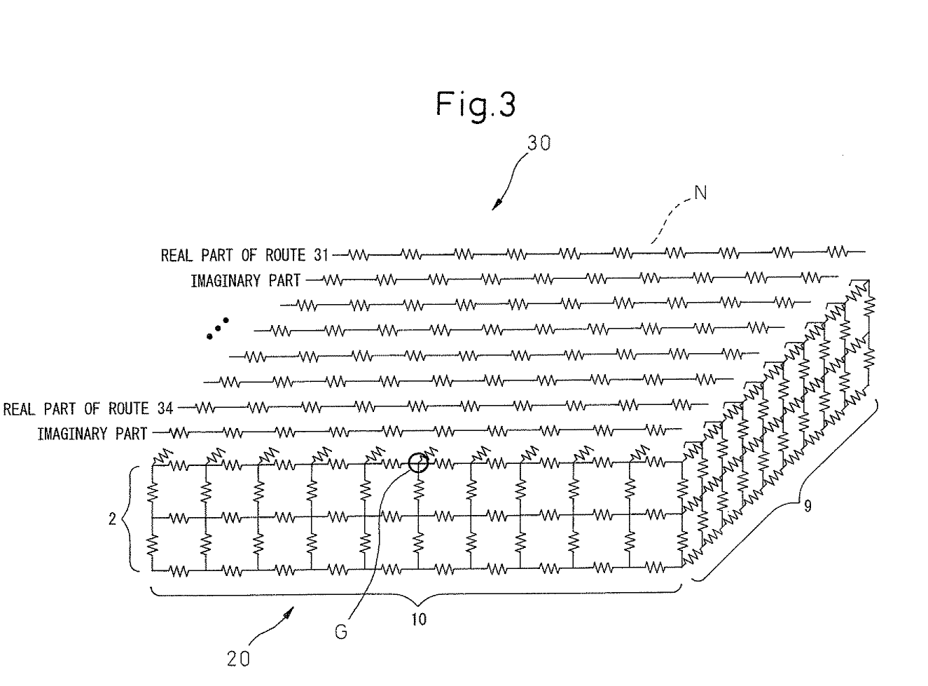

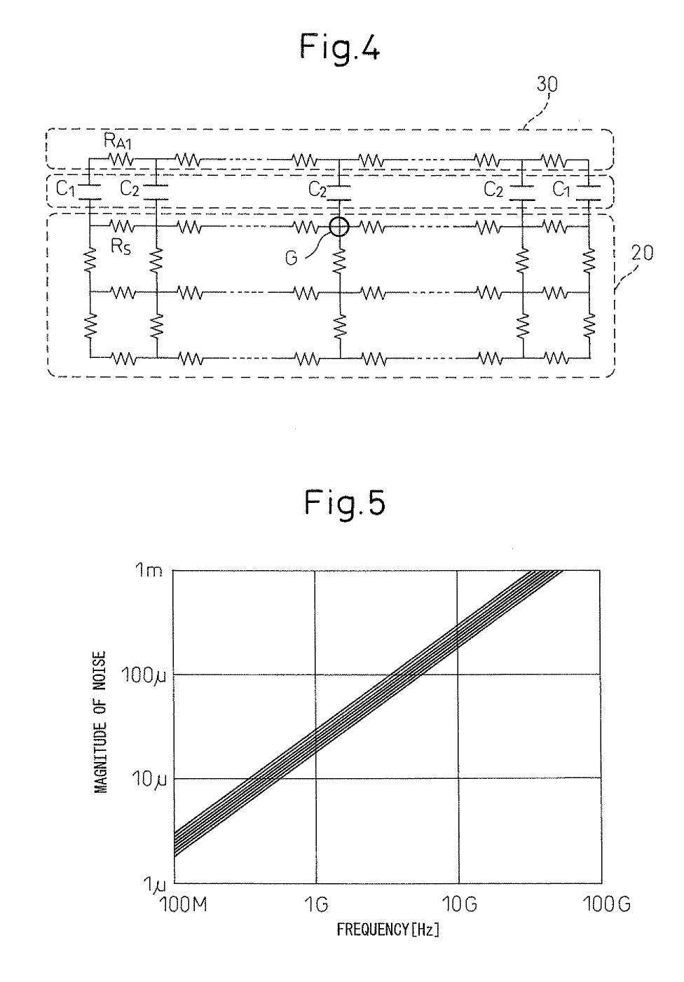

A model where aluminum interconnects 30 of >H(s)=1, that is, for just passing signals, are arranged on the circuit board 20 of FIG. 2 is shown in FIG. 3. There are four signal routes, that is, the routes 31 to 34. Considering a complex signal, there are eight signal lines. FIG. 4 shows a side view of FIG. 3. The aluminum interconnects 30 stick out from the board 20, so the parasitic capacity is expressed as the capacitors C1 (only board ends) and C2.

The noise from the noise source N is believed to be transmitted from the route 31 of FIG. 3 through the routes 32, 33, and 34 to the ground point G while attenuating. This is confirmed in the graph of FIG. 5. The abscissa shows the frequency, while the ordinate shows the magnitude of the noise in logarithmic scales. The eight lines arranged in order from the top correspond to the eight interconnects of the interconnect routes 31 to 34 arranged from near the noise source of FIG. 3. The fact that the noise is transmitted from the route 31 to the route 34 while being attenuated is clearly shown.

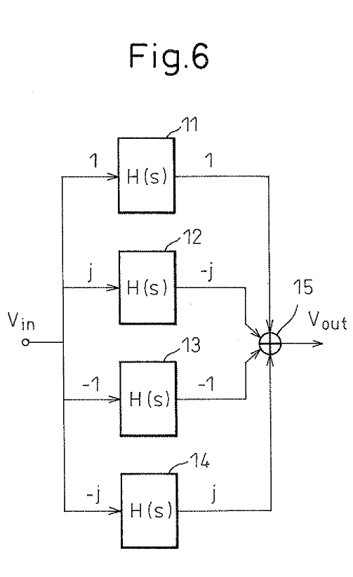

FIG. 6 shows the outline of the circuit configuration of a first embodiment of the present invention. Considering the system of a communication system, the input signal is made a complex signal and that complex signal is divided into four. From the top of the figure, four first to fourth signal processing circuits 11 to 14 are arranged. The signal processing circuits 11 to 14 are all circuits performing the same signal processing H(s). The weight of the input of the signal processing circuit 11 is 1, while the weight of the output is 1. The weight of the input of the signal processing circuit 12 is j, while the weight of the output is −j. The weight of the input of the signal processing circuit 13 is −1, while the weight of the output is −1. The weight of the input of the signal processing circuit 14 is −j, while the weight of the output is j. The weight of the output is in a complex conjugate relation with the weight of the input. The weighted outputs of the signal processing circuits 1 to 4 are added by the adder 15 to obtain the signal output Vout.

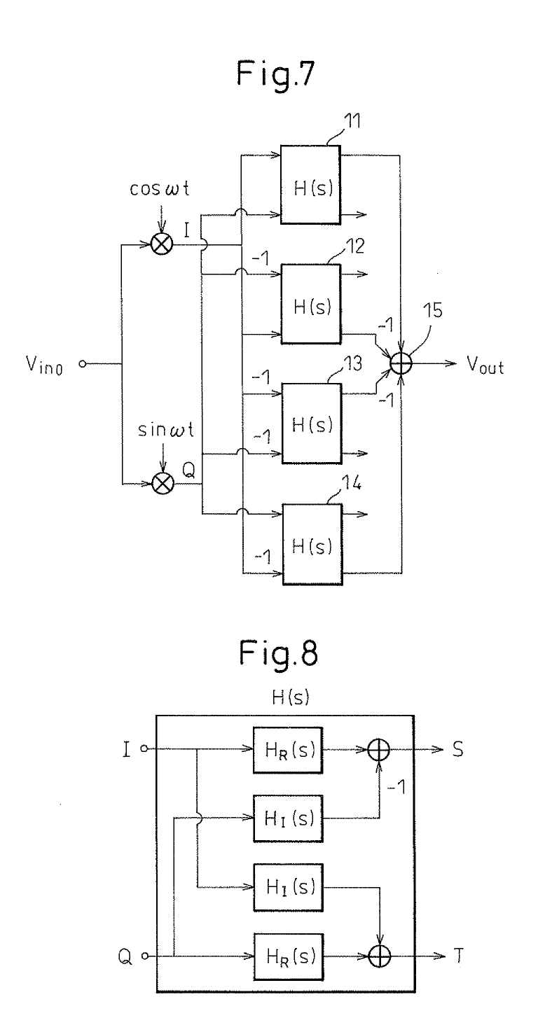

FIG. 7 shows the actual circuit configuration of FIG. 6. The original input for obtaining the complex input is Vin0. This is multiplied with cos ωt and sin ωt to obtain a real part (I signal) and imaginary part (Q signal). The first signal processing circuit 11 has an input weight of 1, so receives as input the I signal and Q signal as they are. The second signal processing circuit 12 has an input weight of j. That is, if multiplying the complex signal Vin0 (cos ωt+j sin ωt) with j, the following is obtained:

−Vin0 sin ωt−j Vin 0 cos ωt

Therefore, the second signal processing circuit 12 receives as an input signal a signal obtained by multiplying the Q signal Vin0 sin ωt with −1 to obtain the real part and having the I signal Vin0 cos ωt as an imaginary part. Below, in the same way, in the illustrated relationship, the third and fourth input signals are produced. These signals are processed by the same signal processing at the signal processing units, then are weighted by the output weights and added. That is, in the first signal processing circuit 11, the output weight is 1, so the signal of the real part is output, in the second signal processing circuit 12, the output weight is −j, so the imaginary part of the signal multiplied with −1 is output, in the third signal processing circuit 12, the output weight is −1, so the real part of the signal multiplied with −1 is output, and in the fourth signal processing circuit 12, since the output weight is j, the imaginary part of the signal is output and these added. The result becomes the signal Vout of the real part of the output. The imaginary part of the signal differs from the real part of the signal in only the phase and is often unnecessary, so will be omitted here.

FIG. 8 is a view for generally explaining the operations of the signal processing circuits 11 to 14. The input of H(s) is the complex signal I+jQ. Since H(s)=H_{R}(S)+jH_{I}(s), the output of H(s) becomes

H(s)(I+jQ)=(H_{R}(s)I−H_{I}(s)Q)+j(H_{R}(s)Q+H_{I}(s)I)

Therefore, the outputs S and T of FIG. 8 become

S=H_{R}(s)I−H_{I}(s)Q

T=H_{R}(s)Q+H_{I}(s)I

In this embodiment, as explained above, H_{I}(s)=0 and H_{R}(s)=1 are set.

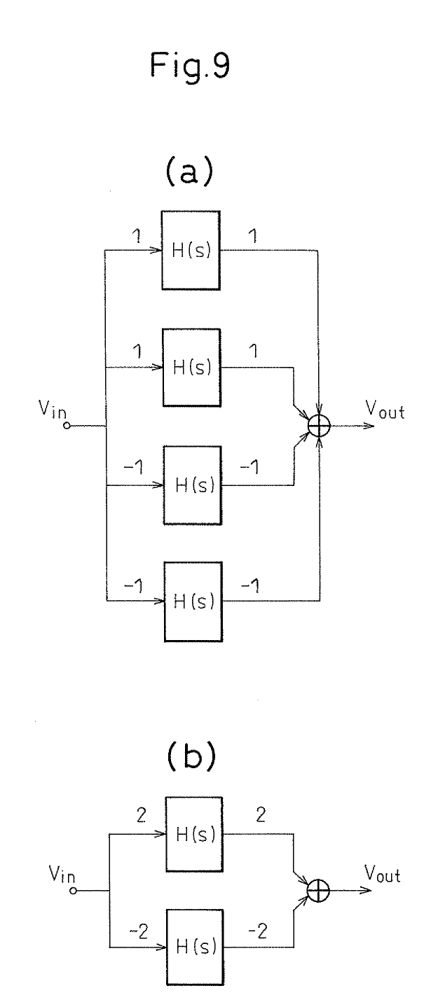

FIG. 9(a) configures a conventional balanced configuration circuit as a four-division circuit.

The four first to fourth signal processing circuits are all circuits performing the same signal processing H(s). From the top of the figure, the weights of the inputs are 1, 1, −1, −1, while the weights of the outputs are, like the weights of the inputs, 1, 1, −1, −1. FIG. 9(b) shows a two-division circuit equivalent to the four-division circuit of FIG. 9(a). In the two-division circuit of FIG. 9(b), to match the coefficients with the four-division circuit of FIG. 9(a), the weights of the input and output are made 2 and −2. The operation of this type of balanced circuit is the same as the conventional circuit of FIG. 18, so the explanation will be omitted.

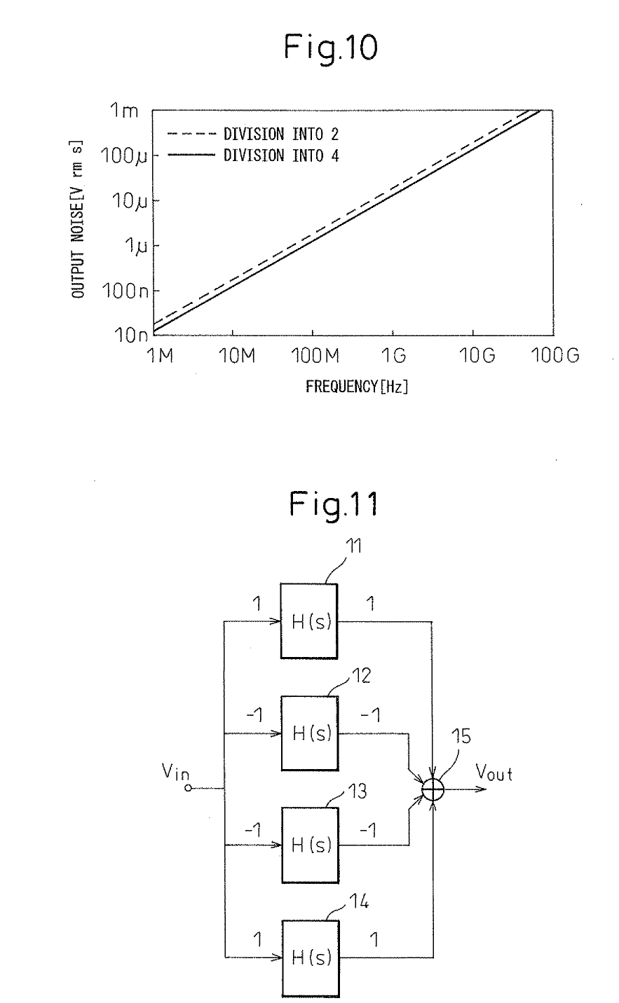

FIG. 10 shows the results of simulation for these. The abscissa shows the frequency in the range of 1 MHz to 100 GHz, while the ordinate shows the output noise by effective value (rms) in the range of 10 nV to 1 mV. The broken line in the figure shows the noise with the conventional balanced configuration, while the solid line shows the noise when using four complex divided signals in the first embodiment of the present invention. As clear from the figure, the noise drops about 3 dB. In the above way, the present embodiment employs the four-divided signals of the weightings [1 j −1 j] for a complex signal, so the noise reduction effect is remarkable. In particular, this is suitable for an integrated circuit in which analog circuits and digital circuits are mixed.

FIG. 11 shows a second embodiment of the present invention. The second embodiment is the case of configuration not for a complex signal, but for a real signal. In this case, a better result is obtained than the case of envisioning a complex signal. The circuit configuration of FIG. 11 itself is the same as in FIG. 6, but has a real signal as input, has the input weights of [1 −1 −1 1], and therefore has the output weights of [1 −1 −1 1].

The operation of this embodiment is expressed by the following equation:

$$[ 1 - 1 - 1 \; 1 ] H ( s ) ( \begin{matrix}1 \\ - 1 \\ - 1 \\ 1\end{matrix} ) {V}_{in} = 4 H ( s ) {V}_{in} \qquad ( 3 )$$

That is, the input signal Vin is multiplied with [1 −1 −1 1]^{T} to divide it into four signals which are then processed, then multiplied with [1 −1 −1 1] and added to obtain the output signal 4H(s)Vin. In this case, for example, the following noise is eliminated:

$$[ 1 - 1 - 1 \; 1 ] H ( s ) ( \begin{matrix}1 \\ 1 \\ 1 \\ 1\end{matrix} ) {V}_{noise} = 0 \\ [ 1 - 1 - 1 \; 1 ] H ( s ) ( \begin{matrix}1 \\ - 1 \\ - 1 \\ 1\end{matrix} ) {V}_{noise} = 0 \qquad ( 4 )$$

In this way, the components perpendicular to the four dimensional vector [1 −1 −1 1]^{T} are all removed. Therefore, even noise components which could not be removed in the past are also removed. It will be understood that the more the number of divisions is increased, the better the characteristics of the circuit or system that can be constructed.

The action and effect of the present invention on the noise riding on the signal of the integrated circuit explained above will be explained next. Assume that the noise prescribed by the model of FIG. 2 is applied to the circuits while attenuating (since not complex signal, four interconnects). At this time, the sum of the noise outputs from the circuits can be expressed as follows defining the noise of the interconnect closest to the noise source as “1” and assuming the noise attenuates for the next interconnect by the attenuation coefficient A (0<A<1):

1−A−A²+A³=(1−A)(1−A²)

On the other hand, with the conventional balanced configuration, the weighting is performed as shown in FIG. 9(a), so the result becomes:

1+A−A²−A³=(1+A)(1−A²)

Since 1−A<1+A, clearly the noise of the present embodiment divided into four is small.

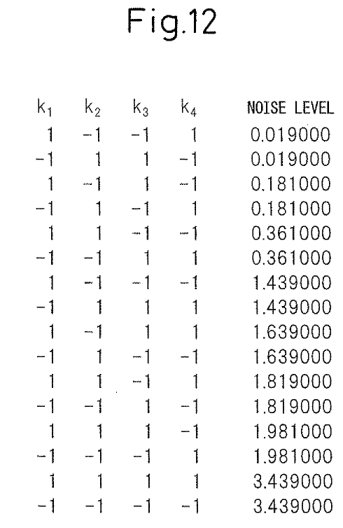

FIG. 12 shows the results when calculating what extent the noise level becomes due to weighting of division into four when assuming the present model and an attenuation coefficient A=0.9.

As clear from the table of FIG. 12, when the weight is made [1 −1 −1 1], the case of making the signs of the components opposite, that is, [−1 1 1 −1], is the greatest in noise reduction effect. Therefore, in the case of division into four, these two types of weights should be selected. Further, the optimum weight in the case of division into eight can be deduced to a certain extent from the case of division into four. The [1 −1 −1 1 −1 1 1 −1] and [−1 1 1 −1 1 −1 −1 1] of the combinations of weightings with the greatest effect in division into four are greatest in noise reduction effect. The noise level becomes 0.006534.

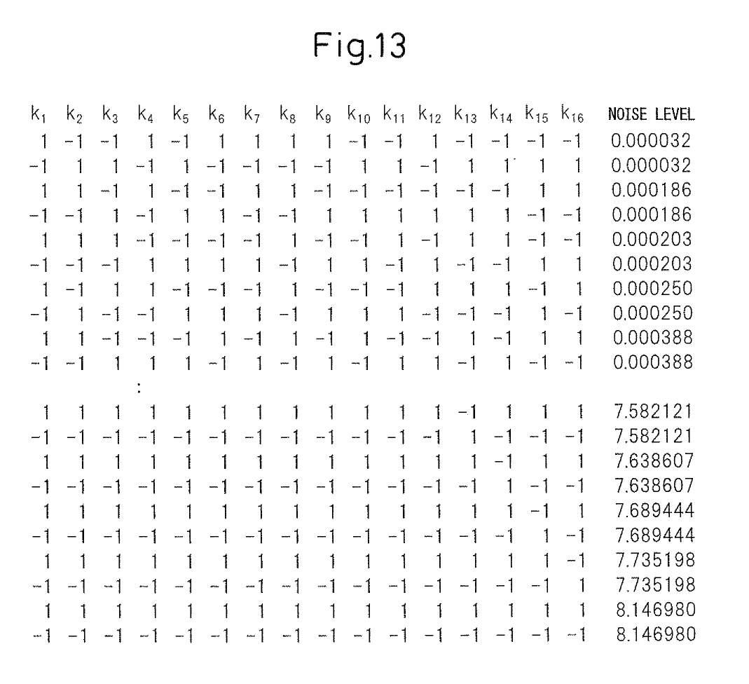

FIG. 13 shows the correspondence between the weighting when dividing an input signal into 16 and the noise level. In the case of division into 16, as will be understood from the table, the optimal combinations of weightings are [1 −1 −1 1 −1 1 1 1 1 −1 −1 1 −1 −1 −1 −1] and [−1 1 1 −1 1 −1 −1 −1 −1 1 1 −1 1 1 1 1]. The noise level becomes 0.000032. The optimal combinations in the case of division into 16 cannot be predicted from the case of division into four or division into eight. Further, it is learned that if increasing the number of divisions, the noise level falls.

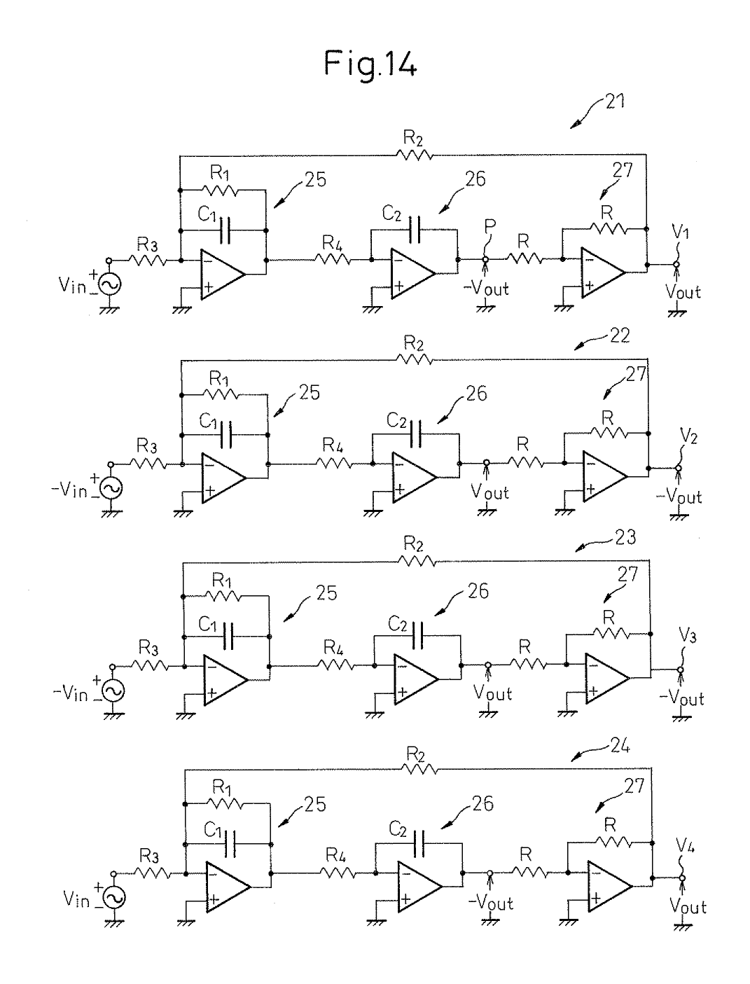

FIG. 14 shows an example of the signal processing circuits 11 to 14 when dividing the signal into four by the input weights of [1 −1 −1 1] and the output weights of [1 −1 −1 1] shown in FIG. 11. The signal processing units 21 to 24 of FIG. 14 include the signal processing circuits 11 to 14 and weightings of the input. Therefore, if weighting and adding the outputs V₁ to V₄ of the signal processing units 21 to 24, an output reduced in noise is obtained. The signal processing units 21 to 24 of FIG. 14 are known second order low pass filters comprised of an incomplete integration circuit 25, a complete integration circuit 26, and an inverted amplification circuit 27 inserted into a negative feedback loop. Due to this, the following function is realized as H(s):

H(s)=b₀/(s²+a₁s+a₀)

In the circuit shown in FIG. 1 as the basic configuration of the present invention, the signal processing circuits 1 to n are assumed to operate independently. In the circuit of FIG. 14 as well, the processing units 21 to 24 operate independently. However, it is also possible to configure the signal processing circuits to be linked with each other or so as interfere with each other so as to simplify the circuit configuration.

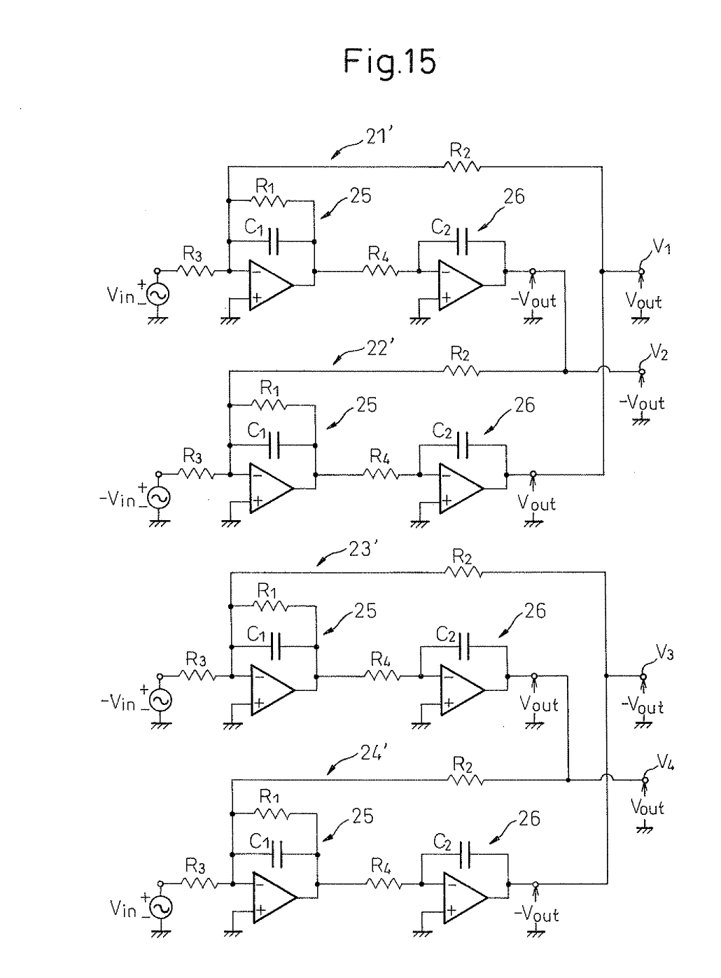

The circuit shown in FIG. 15 is an example of combining the signal processing units 21 and 22 and the signal processing units 23 and 24 of FIG. 14 so as to simplify the circuit configuration. The signal processing units 21′ to 24′ of FIG. 15 exclude the inverted amplifiers 27 of the signal processing units 21 to 24 of FIG. 14, so the processing unit 211 outputs V₂ and the processing unit 22′ outputs V₁. Further, the processing unit 23′ outputs V₄, while the processing unit 24′ outputs V₃. This utilizes the fact that V₁ and V₂ and V₃ and V₄ are mutually inverted signals and the input of the inverted amplification circuit 27 for obtaining V₁ is equal to V₂. For example, at the point P of the processing unit 21, a signal equal to the output V₂ of the processing unit 22 appears, so this is made V₂. In this way, it is possible to utilize the relationship between the circuits to simply configure a signal processing circuit.

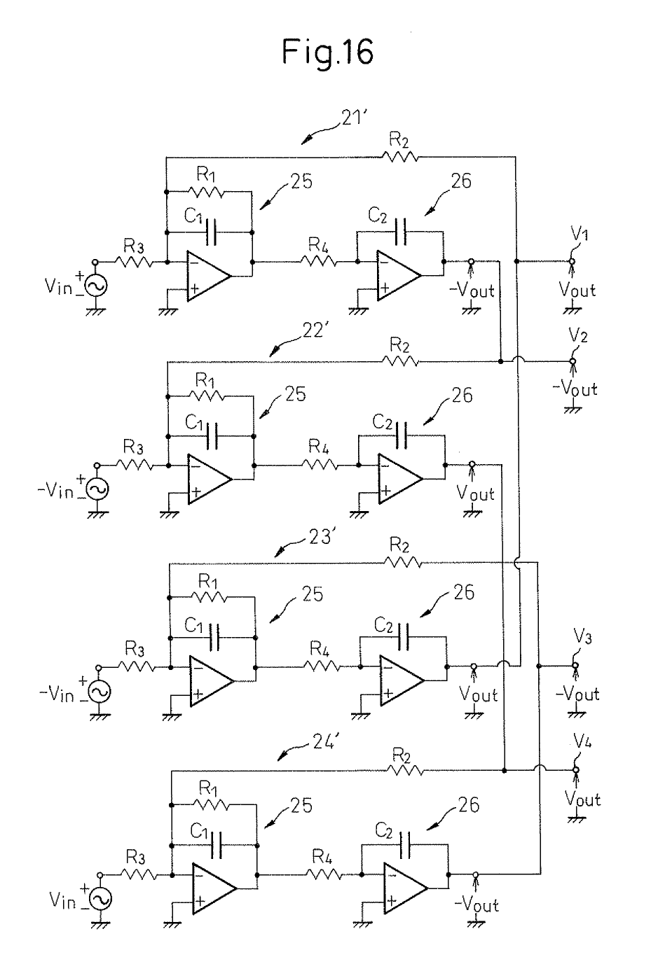

The circuit shown in FIG. 16 is a combination of the signal processing units 21′ to 24′ of FIG. 15 as a whole linked together. For example, the output of the signal processing unit 21′ becomes V₂, the output of the signal processing unit 22′ becomes V₄, the output of the signal processing unit 23′ becomes V₁, and the output of the signal processing unit 24′ becomes V₃. The circuit of FIG. 16, like the circuit of FIG. 15, can simplify the signal processing circuit.

However, according to the present invention, it is possible to reduce not only the harmonic even order distortion, but also the odd order distortion by the signal processing circuit. Below, a third embodiment of the present invention will be explained in comparison with a conventional balanced circuit.

In a conventional balanced circuit utilizing two divided signals, even order distortion can be removed as follows. For example, if considering the case where the input signal vin is input to an amplification circuit with an amplification degree α (constant which is not zero), in general, the output includes not only vout=αvin, but also second order and higher distortion components. The fourth order and higher terms are very small, so if ignoring them and showing up to the third order term, the result becomes:

vₒᵤₜ=a₀+a₁vᵢₙ+a₂vᵢₙ²+a₃vᵢₙ³ (5)

a₀ to a₃ are constants determined by the signal processing circuit.

In a conventional balanced configuration circuit using division into two, the inverted input signal −vin is used, so if inputting −vin in equation (5) and obtaining the difference, the result becomes

2a₁vᵢₙ+2a₃vᵢₙ³

In this way, with a balanced configuration, it is possible to make the second order term zero and remove the second order distortion. However, it is not possible to eliminate the third order distortion.

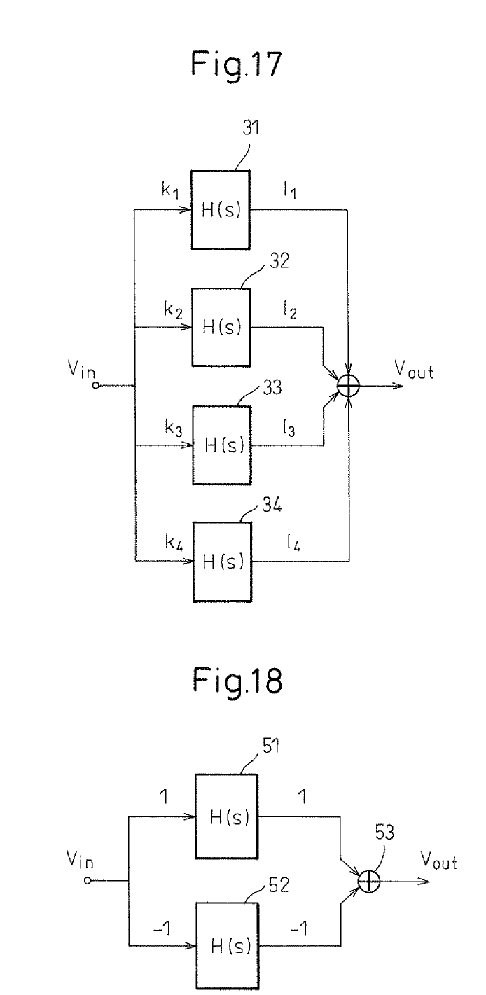

The third embodiment of the present invention is shown in FIG. 17. In the same way as the first and second embodiments, it divides a signal into four for processing. However, the weightings are different from those of the first and second embodiments. The first to fourth signal processing circuits 31 to 34 have the input side weights k₁ to k₄ and output side weights l₁ to l₄. If the input voltage vin is given, the first to fourth signal processing circuits 31 to 34 are respectively given the input voltage of the input voltage vin multiplied with k₁, the input voltage of the input voltage vin multiplied with k₂, the input voltage of the input voltage vin multiplied with k₃, and the input voltage of the input voltage vin multiplied with k₄. At this time, the outputs vouti (i=1 to 4) of the first to fourth signal processing circuits 31 to 34 become:

vₒᵤₜ₁=a₀+a₁(k₁vᵢₙ)+a₂(k₁vᵢₙ)²+a₃(k₁vᵢₙ)³

vₒᵤₜ₂=a₀+a₁(k₂vᵢₙ)+a₂(k₂vᵢₙ)²+a₃(k₂vᵢₙ)³

vₒᵤₜ₃=a₀+a₁(k₃vᵢₙ)+a₂(k₃vᵢₙ)²+a₃(k₃vᵢₙ)³

vₒᵤₜ₄=a₀+a₁(k₄vᵢₙ)+a₂(k₄vᵢₙ)²+a₃(k₄vᵢₙ)³ (6)

Here, if multiplying the outputs vouti with the weights li (i=1 to 4) and adding the results, the output voltage vout is obtained. That is, the output vout becomes

vₒᵤₜ=l₁vₒᵤₜ₁+l₂vₒᵤₜ₂+l₃vₒᵤₜ₃+l₄vₒᵤₜ₄

=a₀(l₁+l₂+l₃+l₄)+a₁(l₁k₁+l₂k₂+l₃k₃+l₄k₄)v²in+a₂(l₁k₁²+l₂k₂²+l₃k₃³+l₄k₄⁴)v³in+a₃(l₁k₁³+l₂k₂³+l₃k₃³+l₄k₄³)vᵢₙ (7)

At this time, if the following conditions stand:

l₁+l₂+l₃+l₄=0

l₁k₁+l₂k₂+l₃k₃+l₄k₄=α

l₁k₁²+l₂k₂²+l₃k₃²+l₄k₄²=0

l₁k₁³+l₂k₂³+l₃k₃³+l₄k₄³=0 (8)

regardless of the constants a₀ to a₃ determined by the characteristics of the signal processing circuits, the condition of the ideal amplifier

vout=αa₁vin(α≠0)

stands. The weights l₁ to l₄ can be found as follows if viewing equation (8) as four first order simultaneous equations having l₁ to l₄ as unknowns

$${l}_{1} = - \frac{α ( {k}_{2} {k}_{3} + {k}_{3} {k}_{4} + {k}_{4} {k}_{2} )}{( {k}_{4} - {k}_{1} ) ( {k}_{3} - {k}_{1} ) ( {k}_{2} - {k}_{1} )} \\ {l}_{2} = - \frac{α ( {k}_{1} {k}_{3} + {k}_{3} {k}_{4} + {k}_{4} {k}_{1} )}{( {k}_{4} - {k}_{2} ) ( {k}_{3} - {k}_{2} ) ( {k}_{1} - {k}_{2} )} \\ {l}_{3} = - \frac{α ( {k}_{2} {k}_{1} + {k}_{1} {k}_{4} + {k}_{4} {k}_{2} )}{( {k}_{4} - {k}_{3} ) ( {k}_{1} - {k}_{3} ) ( {k}_{2} - {k}_{3} )} \\ {l}_{4} = - \frac{α ( {k}_{2} {k}_{3} + {k}_{3} {k}_{1} + {k}_{1} {k}_{2} )}{( {k}_{1} - {k}_{4} ) ( {k}_{3} - {k}_{4} ) ( {k}_{2} - {k}_{4} )} \qquad ( 9 )$$

In other words, if suitably setting the input side weights k₁ to k₄ and determining the output side weights l₁ to l₄ by equations (9), not only the 0-th order and second order term of vin, but also the third order term can be eliminated. If further increasing the number of divisions (division into five, division into six, etc.), higher order terms can also be eliminated. However, what are becoming problems in current communication systems are the second order term and the third order term, so practically division into four is sufficient. In the above way, according to the present invention, it is possible to remove odd order distortion which could not be removed in the past.

Further, according to the present invention, the number of divided signals processed becomes greater than by a conventional circuit, so the circuits formed on the circuit board increase along with this. However, in an integrated circuit, usually the transistors are large in width, so simple physical division is sufficient. This division of transistors is not that troublesome, so there are few demerits in production.

1. A signal processing method comprising the steps of:
weighting a signal by first weights to obtain three or more divided signals,
processing said divided signals by the same signal processing,
weighting said processed divided signals by second weights, and adding the divided signals weighted by said second weights.

2. A signal processing method as set forth in claim 1 wherein said signal is a complex signal and said second weights are complex conjugate with the corresponding first weights.

3. A signal processing method as set forth in claim 2 wherein said first weights are selected from 1, −1, j, −j.

4. A signal processing method as set forth in claim 1 wherein said signal is a real signal and said second weights are the same as the corresponding first weights.

5. A signal processing method as set forth in claim 3 wherein said first weights are selected from 1 and −1.

6. A signal processing method as set forth in claim 1 wherein said first weights are a combination selected to maximize a noise reduction effect.

7. A signal processing method as set forth in claim 1 wherein said signal is a real signal and said second weights are given as a function of said first weights.

8. A signal processing method as set forth in claim 1 wherein said second weights are given as solutions of simultaneous equations having said second weights as unknowns and having values calculated from said first weights as coefficients.

9. A signal processing method as set forth in claim 7 wherein said second weights are calculated from the first weights so as to reduce the distortion components.

10. A signal processing method as set forth in claim 8 wherein said second weights are calculated from the first weights so as to reduce the distortion components.

11. A signal processing apparatus comprising:
a first weighting means for weighting a signal by first weights to obtain three or more divided signals,
a signal processing means for processing said divided signals by the same signal processing,
a second weighting means for weighting said processed divided signals by second weights, and
an adding means for adding the divided signals weighted by said second weights.

12. A signal processing apparatus as set forth in claim 11 wherein said signal is a complex signal and said second weights are complex conjugate with the corresponding first weights.

13. A signal processing apparatus as set forth in claim 12 wherein said first weights are selected from 1, −1, j, −j.

14. A signal processing apparatus as set forth in claim 11 wherein said signal is a real signal and said second weights are the same as the corresponding first weights.

15. A signal processing apparatus as set forth in claim 14 wherein said first weights are selected from 1 and −1.

16. A signal processing apparatus as set forth in claim 11 wherein said first weights are a combination selected to maximize a noise reduction effect.

17. A signal processing apparatus as set forth in claim 11 wherein said signal is a real signal and said second weights are given as a function of said first weights.

18. A signal processing apparatus as set forth in claim 11 wherein said second weights are given as solutions of simultaneous equations having said second weights as unknowns and having value calculated from said first weights as coefficients.

19. A signal processing apparatus as set forth in claim 17 wherein said second weights are calculated from the first weights so as to reduce the distortion components.

20. A signal processing apparatus as set forth in claim 18 wherein said second weights are calculated from the first weights so as to reduce the distortion components.
